(19) United States
(12) Patent Application Publication
(10) Pub. No.: US 2024/0256245 A1
(43) Pub. Date: Aug. 1, 2024

(54) NAMESPACE SCOPED DEFAULT STORAGE CLASSES

(71) Applicant: International Business Machines Corporation, Armonk, NY (US)

(72) Inventors: Neeraj Kumar Kashyap, Bangalore (IN); Ambika Nair, Bangalore (IN); Mayank Singh Sachan, Hyderabad (IN); Sandip Amin, Austin, TX (US)

(73) Assignee: International Business Machines Corporation, Armonk, NY (US)

(21) Appl. No.: 18/104,280

(22) Filed: Jan. 31, 2023

(51) Int. Cl. G06F 8/61

(52) U.S. Cl. CPC G06F 8/61

(57) ABSTRACT

An example operation may include one or more of receiving, via an application programming interface (API) of a cluster, a persistent volume claim (PVC) with a specification of a software application, identifying a namespace based on a namespace attribute of the PVC, identifying a storage class which is declared as a default storage class for the identified namespace based on the one or more attributes within the PVC and injecting storage criteria of the default storage class into the specification of the software application, and deploying the software application via a node within the identified namespace according to the predefined storage attributes of the default storage class injected into the specification of the software application.

### BACKGROUND

A storage class may represent a specific storage profile that defines requirements for storing data from an application or other software program. For example, a storage class may define various attributes such as a provider, storage type, performance and other capabilities including but not limited to encryption, snapshotting, dynamic resizing, and the like. A software application may request a storage volume based on the storage class through a Persistent Volume Claim (PVC). Within the claim, the application can specify a required size of the volume and it can also specify the storage type by specifying a storage class.

### SUMMARY

One example embodiment provides an apparatus that includes a processor that may be configured to receive, via an application programming interface (API) of a cluster, a persistent volume claim (PVC) with a specification of a software application, identify a namespace based on one or more attributes within the PVC, identify a storage class which is declared as a default storage class for the identified namespace based on the one or more attributes within the PVC and injecting storage criteria of the default storage class into the specification of the software application, and deploy the software application via a node within the identified namespace according to the predefined storage attributes of the default storage class injected into the specification of the software application.

Another example embodiment provides a method that may include one or more of receiving, via an application programming interface (API) of a cluster, a persistent volume claim (PVC) with a specification of a software application, identifying a namespace based on one or more attributes within the PVC, identifying a storage class which is declared as a default storage class for the identified namespace based on the one or more attributes within the PVC and injecting storage criteria of the default storage class into the specification of the software application, and deploying the software application via a node within the identified namespace according to the predefined storage attributes of the default storage class injected into the specification of the software application.

A further example embodiment provides a computer-readable medium comprising instructions, that when read by a processor, may cause the processor to perform a method that includes one or more of receiving, via an application programming interface (API) of a cluster, a persistent volume claim (PVC) with a specification of a software application, identifying a namespace based on one or more attributes within the PVC, identifying a storage class which is declared as a default storage class for the identified namespace based on the one or more attributes within the PVC and injecting storage criteria of the default storage class into the specification of the software application, and deploying the software application via a node within the identified namespace according to the predefined storage attributes of the default storage class injected into the specification of the software application.

### BRIEF DESCRIPTION OF THE DRAWINGS

FIG. 1 is a diagram illustrating a computing environment, according to example embodiments.

FIG. 2A is a diagram illustrating an architecture of a service cluster with namespaces scoped with respective default storage classes, according to example embodiments.

FIG. 2B is a diagram illustrating a process for assigning a default storage class, according to example embodiments.

FIG. 2C is a diagram illustrating a process for assigning a default storage class, according to example embodiments.

FIG. 3A is a diagram illustrating a permissioned network, according to example embodiments.

FIG. 3B is a diagram illustrating another permissioned network, according to example embodiments.

FIG. 3C is a diagram illustrating a further permissionless network, according to example embodiments.

FIG. 3D is a diagram illustrating machine learning process via a cloud computing platform, according to example embodiments.

FIG. 3E is a diagram illustrating a quantum computing environment associated with a cloud computing platform, according to example embodiments.

FIG. 4A is a diagram illustrating an example of a virtual storage class defined for a cluster, according to example embodiments.

FIG. 4B is a diagram illustrating examples of configuration files which define different default storage classes for different namespaces in a same cluster, according to example embodiments.

FIG. 4C is a diagram illustrating a process of injecting a default storage class into a persistent volume claim, according to example embodiments.

FIG. 4D is a diagram illustrating a persistent volume claim submitted to a cluster, according to example embodiments.

FIG. 4E is a diagram illustrating a modified persistent volume claim generated by the cluster, according to example embodiments.

FIG. 4F is a diagram illustrating a persistent volume claim submitted to a cluster, according to example embodiments.

FIG. 4G is a diagram illustrating a modified persistent volume claim generated by the cluster, according to example embodiments.

FIG. 5 is a diagram illustrating a method of injecting a default storage class scoped to a namespace into an application, according to example embodiments.

### DETAILED DESCRIPTION

It is to be understood that although this disclosure includes a detailed description of cloud computing, implementation of the teachings recited herein is not limited to a cloud computing environment. Rather, embodiments of the present instant solution are capable of being implemented in conjunction with any other type of computing environment now known or later developed.

Normally cluster administrators (users) may set a cluster-wide default storage class for all workloads running in the cluster that dynamically request a persistent volume storage without specifying any particular storage class. This is very common in a hybrid cloud deployment. However, in this case, the cluster may be shared by a large organization with multiple teams hosting multiple storage agnostic workloads which may work better with different types of storage, may require different sizes of storage, may have different performance and quality of service requirements, and the like.

The example embodiments are directed to namespace-scoped default storage classes inside a container cluster (for example a KUBERNETES® cluster). This differs from the traditional process in which default storage classes are cluster wide. By enabling namespace-specific default storage classes, the example embodiments enable a container-based server (for example a KUBERNETES® server) to create different virtual environments with different process, storage, bandwidth, etc., within the same cluster. The process can significantly benefit large scale corporations in which users are managed in groups and the groups have different requirements that are often isolated and unrelated. For example, a cluster may have multiple different possible storage classes that are available. A storage classes may be declared as cluster default storage class by an administrator via a service of the KUBERNETES® server. The cluster default storage classes may be referred to as “global” default storage classes because they are available and known by all namespaces in a cluster.

In addition, the server may configure or otherwise define a default storage class to a particular namespace within a cluster. This same process can be performed for different namespaces within a same cluster thereby enabling different default storage classes among different workloads within a single cluster of a KUBERNETES® server. Accordingly, when a cluster is shared by multiple teams hosting multiple agnostic workloads such as is common in a hybrid cloud scenario, the server can configure different default storage classes within different namespaces inside the same cluster thereby providing optimal storage and other resources to different workloads based on the types of workloads, duration, and the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

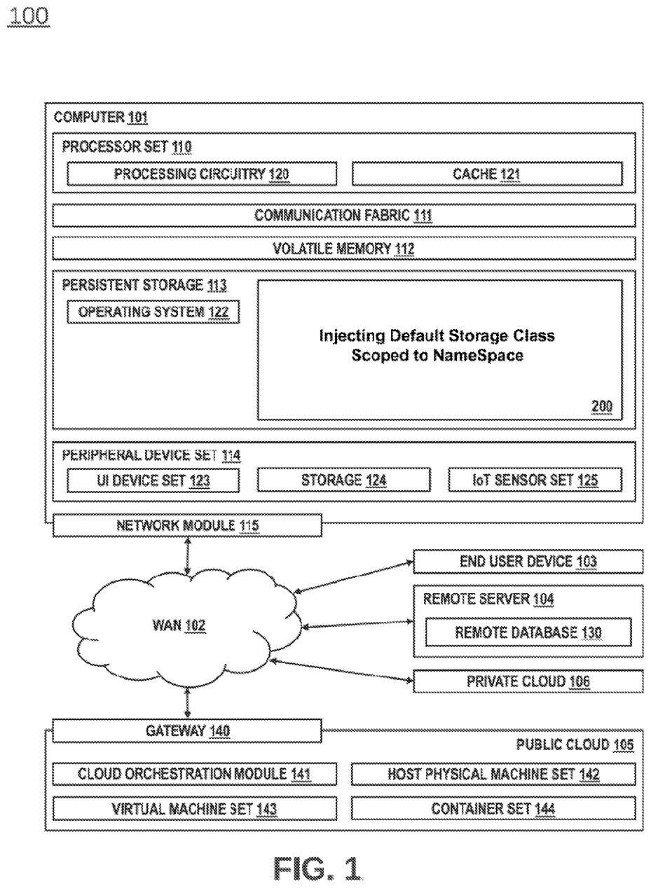

Referring now to FIG. 1, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for executing at least some of the computer code involved in performing the inventive methods, such as injecting default storage classes scoped to namespace 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTE®101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric comprises switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

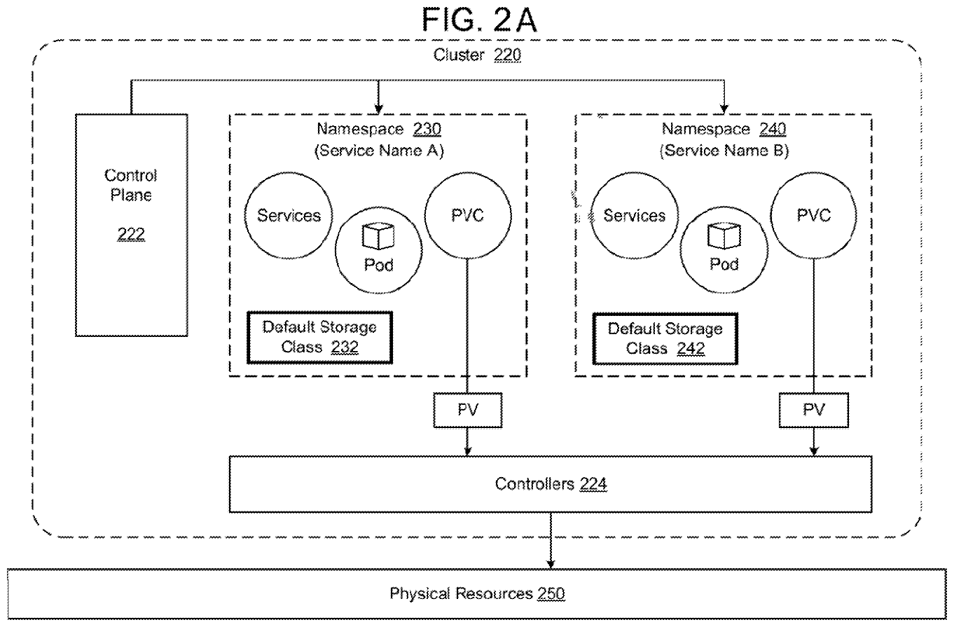

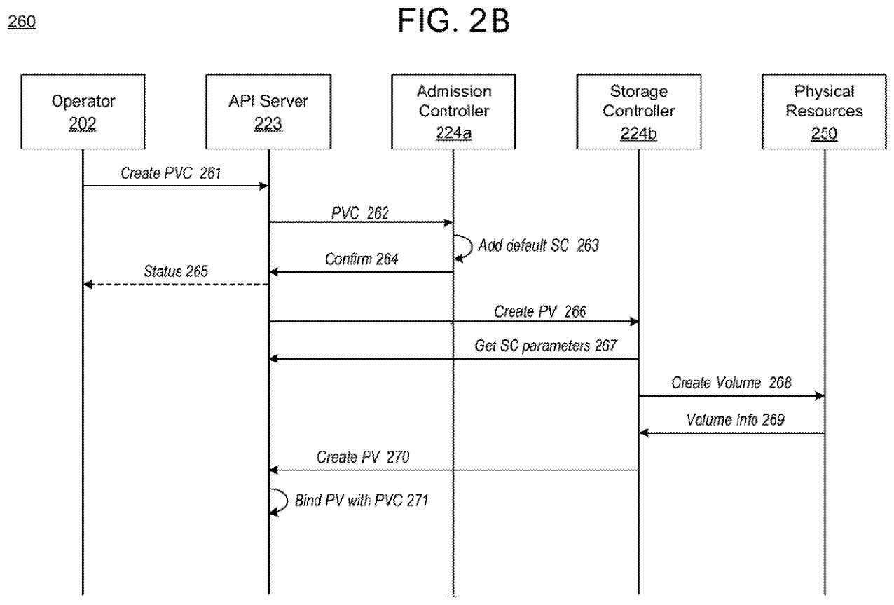

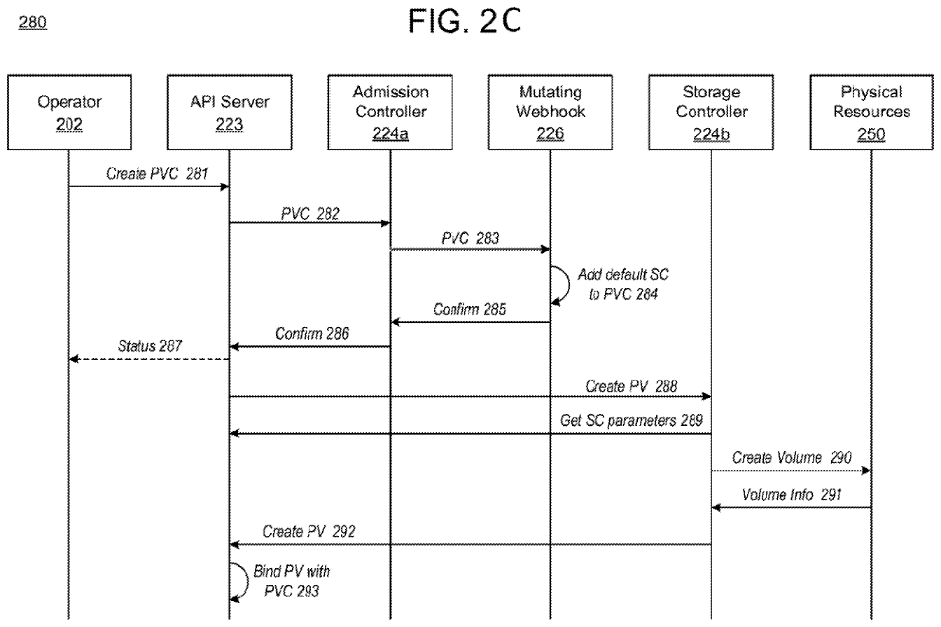

FIG. 2A illustrates an architecture of a service cluster 220 with two namespaces that have each been scoped with different respective default storage classes according to example embodiments. As described herein, the “scoping” of the namespace refers to the declaring of a default storage class for that specific namespace. It should also be appreciated that more than one default storage class may be declared for a same namespace based on storage type attribute. The default storage class for a namespace may be declared or otherwise specified within a configuration file assigned to the namespace. The configuration file may identify one or more default storage classes for the namespace based on the attributes such as storage type, quality of service, etc. It should also be appreciated that multiple namespaces may exist within a cluster. The architecture enables customizing and dynamically assigning resources to different software programs, user groups, workloads, and the like, of a shared set of resources such as those set in place for a single organization.

When a software application is deployed in cluster, it requires storage (e.g., a persistent volume, etc.). Here, the software application operator may attach a persistent volume claim (PVC) to the software application which can be intercepted by a service of the cluster, such as an API service of a control plane of the cluster. The PVC may specify a storage class (e.g., standard, gold, silver, default, etc.), an access mode, a storage capacity, and the like. The PV object is bound or mapped to PVC. The PV specification includes details to access the volume.

Referring now to FIG. 2A, the cluster 220 includes a namespace 230 and a namespace 240 which are managed by a controller 224 and consume physical resources 250 such as virtual machines, networking bandwidth, processing bandwidth, storage (persistent volume), and the like. Each of the namespace 230 and the namespace 240 includes services, PVC and a pod(s) which includes one or more nodes for processing the applications hosted therein. The cluster also includes a control plane 222 which includes an API server, a persistent data store, a cloud controller, a container-based controller (for example a KUBERNETES® controller), and the like. The control plane 222 manages the nodes (e.g., groups of computers, etc.) which host containerized software applications with the namespaces 230 and 240. For example, the control plane 222 may create new nodes, re-assign nodes to different pods, clusters, etc., and configure workloads for processing within the namespaces 230 and 240. The control plane 222 can determine how many resources to apply to each namespace and may also provide a user interface that enables users to configure the various settings.

In this example, one or more default storage classes may be declared for each namespace and the default storage classes can be different within the different namespaces even though the namespaces are in the same cluster. For example, a first default storage class 232 has been defined for the namespace 230 and a second default storage class 242 which is different than the first default storage class 232 has been defined for the namespace 240 of the cluster 220. As a simple example, the first default storage 232 may be a NFS type of file storage class and the second default storage 242 may refer to a block-level type of storage class. Accordingly, different workloads which operate ideally with different storage classes can be hosted within a same cluster 220 of a KUBERNETES® server. Furthermore, the namespaces provide isolation from other namespaces within the cluster 220 making it isolated and secure.

When a software application is sent for deployment to the cluster 220, the control plane 222 may intercept or otherwise read a persistent volume claim attached to or otherwise appended to the software application. Within the PVC may be an identifier of a storage class and an identifier of a namespace where the application is to be hosted. If no storage class is identified, then the system knows to use a “default” storage class. Traditionally, such default storage class is defined on a global basis.

However, as described herein, default storage classes can be declared per namespace. Furthermore, multiple different default storage classes can be declared for a namespace based on attributes like storage type (block vs file). Thus, the ability to operate different application workloads for different storage capabilities available in a same cluster is now possible. As a result, a customer does not need to purchase or otherwise occupy more than one cluster of the KUBERNETES® server or Application Operator does not need to understand the various storage option available on the target cluster. For example, an application may perform better with block-level storage. In this case, the first application may include a persistent volume claim without specific storage class name and just specify the desired storage type by defining storage type annotation attribute in the PVC. In response, the control plane 222, with the help of namespace scoped default storage class mutating webhook, may identify the storage class to be assigned to the PVC.

FIG. 2B illustrates a process 260 for assigning a default storage class according to an example embodiment. Referring to FIG. 2B, the process 260 is performed by an operator 202 (e.g., a person) who interacts with the system via a user interface, input mechanisms, and the like. The operator 202 requests creation of a persistent volume claim (PVC) in 261. The PVC may include a specification for persistent storage volume of a software application that is to be hosted within the cluster 220 shown in FIG. 2A. Here, the request is sent to an API server 223 of the cluster 220, which forwards the PVC request to an admission controller 224a in 262. The admission controller 224a may be included in the controller 224 of FIG. 2A. Here, the admission controller 224a adds storage criteria/attributes of the default storage class which has been declared by a cluster administrator (for the cluster 222) to the PVC if a storage class is not explicitly specified in the specification, in 263. The predefined storage attributes may include a storage type identifier, a quality of service/class identifier, a storage capacity parameter, and the like.

In 264, Admission controller returns to the API server 223 for further processing of the PVC creation request and finally creates PVC object and then returns to the operator 202 in 265 in the form of a status/confirmation. In 266, the storage controller 224b detects PVC object with status Pending. In response, the storage controller 224b retrieves the parameters/predefined attributes of the storage class as per storage class name attribute of the PVC from the API server 223. The parameters may include access mode identifier, storage type identifier, quality of service, etc. In 268, the storage controller 224b generates a persistent volume storage for the application within the physical resources 250 of the system such as within a database or other storage device. The storage controller 224b receives confirmation and location details of the persistent volume in 269, and forwards it to the API server 223 in 270. In 271, the API server 223 binds the Persistent Volume (PV) object to the PVC object and that completes the provisioning of the persistent volume.

FIG. 2C illustrates a process 280 for assigning a default storage class according to another example embodiment. In this example, steps 281, 282, 286, 287, 288, 289, 290, 291, 292, and 293 correspond to steps 261, 262, 264, 265, 266, 267, 268, 269, 270, and 271 shown in FIG. 2B. However, instead of step 263, in FIG. 2C, the step is replaced with steps 283, 284, and 285. In 283, instead of the admission controller 224a adding the storage criteria/attributes of the default storage class which have been declared by a cluster administrator (for the cluster 222) to the PVC, a mutating webhook 226 intercepts the PVC creation request sent from the operator to the admission controller 224a via the API server 223 and automatically identifies a default storage class that has been declared for a namespace identifier included in the PVC. The mutating webhook 226 registered with the mutating controller (not shown) that is part of the controller 224a shown in FIG. 2A. In 284, the mutating webhook (e.g., based on execution of a script, program, etc.) adds predefined storage criteria of the identified default storage class declared for the identified namespace to the PVC spec, and forwards it to the admission controller 224a, in 285. In doing so, the process 280 can specify different types of default storage classes for different namespaces within a same cluster of the host platform, thereby enabling wider variety of customizations and reducing the need for the customer to purchase additional clusters on the host platform.

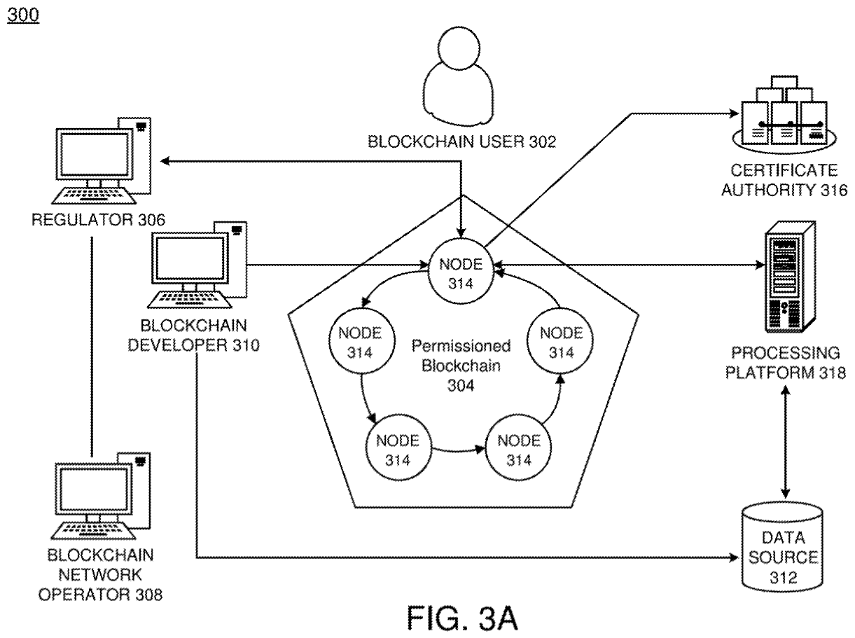

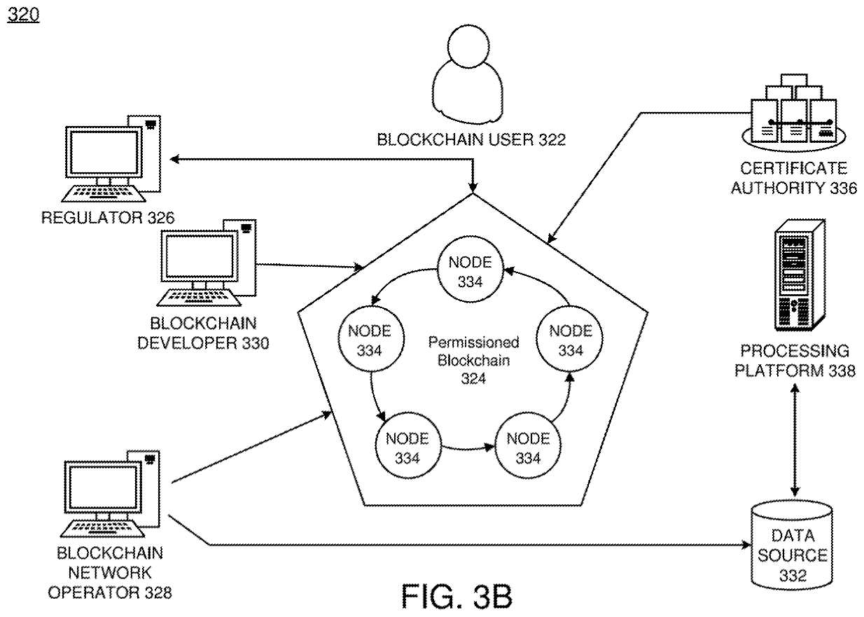

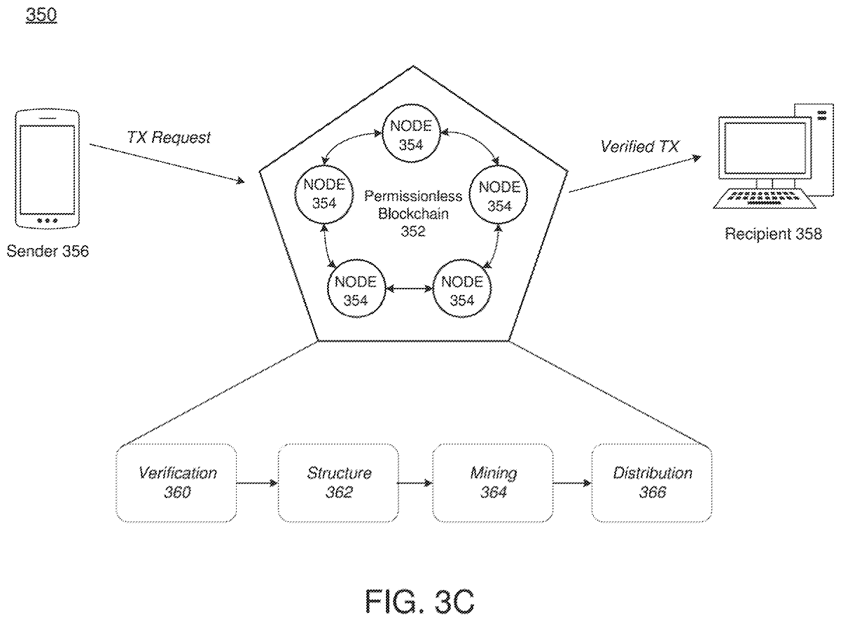

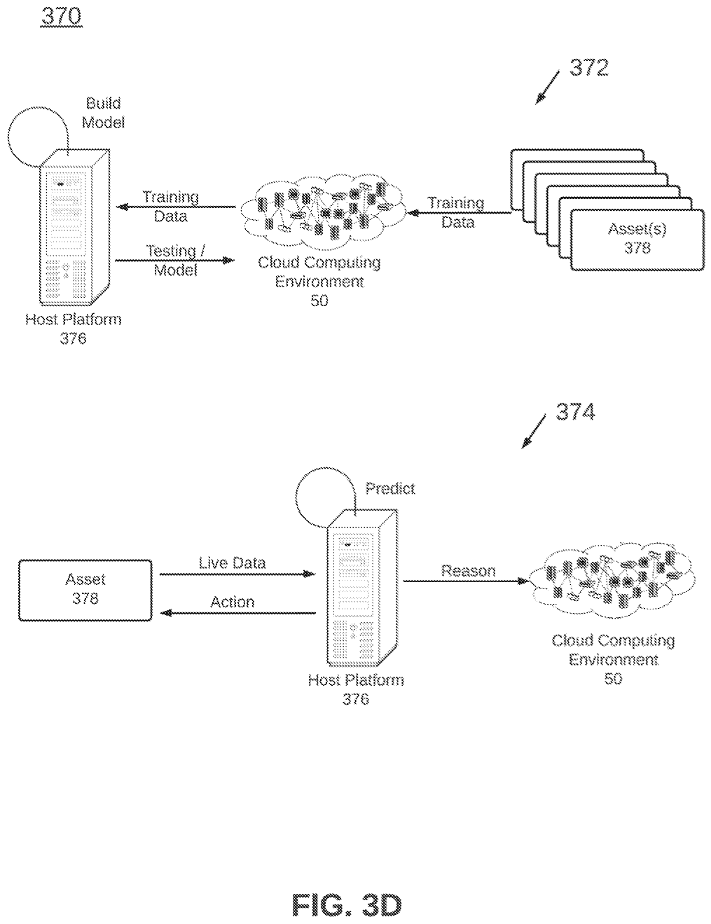

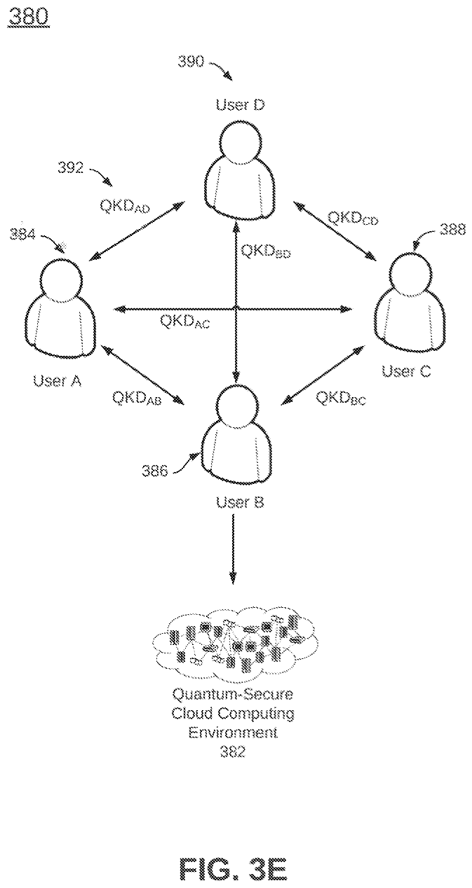

FIG. 3A illustrates an example of a permissioned blockchain network 300, which features a distributed, decentralized peer-to-peer architecture. The blockchain network may interact with the cloud computing environment 160, allowing additional functionality such as peer-to-peer authentication for data written to a distributed ledger. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger, whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger, whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains, which require permission to join, anyone can join a permissionless blockchain. For example, to join a permissionless blockchain a user may create a personal address and begin interacting with the network by submitting transactions and hence adding entries to the ledger. Additionally, all parties have the choice of running a node on the system and employing the mining protocols to help verify transactions.

FIG. 3C illustrates a process 350 of a transaction being processed by a permissionless blockchain 352, including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters, the nodes verify 360 the transaction based on rules (which may be pre-defined or dynamically allocated) established by the permissionless blockchain 352 creators. For example, this may include verifying the identities of the parties involved, etc. The transaction may be verified immediately or it may be placed in a queue with other transactions, and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256-bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW, thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution 366, the successfully validated block is distributed through the permissionless blockchain 352, and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

FIGS. 3D and 3E illustrate additional examples of use cases for cloud computing that may be incorporated and used herein. FIG. 3D illustrates an example 370 of a cloud computing environment 160, which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 3D, a host platform 376, builds and deploys a machine learning model for predictive monitoring of assets 378. Here, the host platform 366 may be a cloud platform, an industrial server, a web server, a personal computer, a user device, and the like. Assets 378 can be any type of asset (e.g., machine or equipment, etc.) such as an aircraft, locomotive, turbine, medical machinery and equipment, oil and gas equipment, boats, ships, vehicles, and the like. As another example, assets 378 may be non-tangible assets such as stocks, currency, digital coins, insurance, or the like.

The cloud computing environment 160 can be used to significantly improve both a training process 372 of the machine learning model and a predictive process 374 based on a trained machine learning model. For example, in 372, rather than requiring a data scientist/engineer or another user to collect the data, historical data may be stored by the assets 378 themselves (or through an intermediary, not shown) on the cloud computing environment 160. This can significantly reduce the collection time needed by the host platform 376 when performing predictive model training. For example, data can be directly and reliably transferred straight from its place of origin to the cloud computing environment 160. By using the cloud computing environment 160 to ensure the security and ownership of the collected data, smart contracts may directly send the data from the assets to the individuals that use the data for building a machine learning model. This allows for sharing of data among the assets 378.

Furthermore, training of the machine learning model on the collected data may take rounds of refinement and testing by the host platform 376. Each round may be based on additional data or data that was not previously considered to help expand the knowledge of the machine learning model. In 372, the different training and testing steps (and the associated data) may be stored on the cloud computing environment 160 by the host platform 376. Each refinement of the machine learning model (e.g., changes in variables, weights, etc.) may be stored in the cloud computing environment 160 to provide verifiable proof of how the model was trained and what data was used to train the model. For example, the machine learning model may be stored on a blockchain to provide verifiable proof. Furthermore, when the host platform 376 has achieved a trained model, the resulting model may be stored on the cloud computing environment 160.

After the model has been trained, it may be deployed to a live environment where it can make predictions/decisions based on executing the final trained machine learning model. For example, in 374, the machine learning model may be used for condition-based maintenance (CBM) for an asset such as an aircraft, a wind turbine, a healthcare machine, and the like. In this example, data fed back from asset 378 may be input into the machine learning model and used to make event predictions such as failure events, error codes, and the like. Determinations made by executing the machine learning model at the host platform 376 may be stored on the cloud computing environment 160 to provide auditable/verifiable proof. As one non-limiting example, the machine learning model may predict a future breakdown/failure to a part of the asset 378 and create an alert or a notification to replace the part. The data behind this decision may be stored by the host platform 376 and/or on the cloud computing environment 160. In one embodiment, the features and/or the actions described and/or depicted herein can occur on or with respect to the cloud computing environment 160.

FIG. 3E illustrates an example 380 of a quantum-secure cloud computing environment 382, which implements quantum key distribution (QKD) to protect against a quantum computing attack. In this example, cloud computing users can verify each other's identities using QKD. This sends information using quantum particles such as photons, which cannot be copied by an eavesdropper without destroying them. In this way, a sender and a receiver through the cloud computing environment can be sure of each other's identity.

In the example of FIG. 3E, four users are present 384, 386, 388, and 390. Each pair of users may share a secret key 392 (i.e., a QKD) between themselves. Since there are four nodes in this example, six pairs of nodes exist, and therefore six different secret keys 392 are used, including QKDAB, QKDAC, QKDAD, QKDBC, QKDBD, and QKDCD. Each pair can create a QKD by sending information using quantum particles such as photons, which cannot be copied by an eavesdropper without destroying them. In this way, a pair of users can be sure of each other's identity.

The operation of the cloud computing environment 382 is based on two procedures (i) creation of transactions and (ii) construction of blocks that aggregate the new transactions. New transactions may be created similar to a traditional network, such as a blockchain network. Each transaction may contain information about a sender, a receiver, a time of creation, an amount (or value) to be transferred, a list of reference transactions that justifies the sender has funds for the operation, and the like. This transaction record is then sent to all other nodes, where it is entered into a pool of unconfirmed transactions. Here, two parties (i.e., a pair of users from among 384-390) authenticate the transaction by providing their shared secret key 392 (QKD). This quantum signature can be attached to every transaction, making it exceedingly difficult to be tampered with. Each node checks its entries with respect to a local copy of the cloud computing environment 382 to verify that each transaction has sufficient funds.

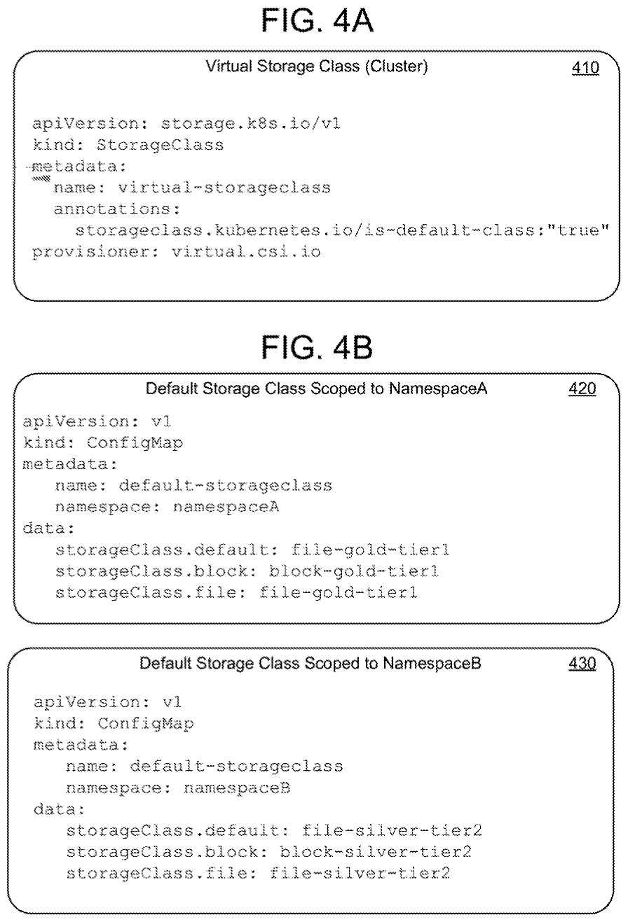

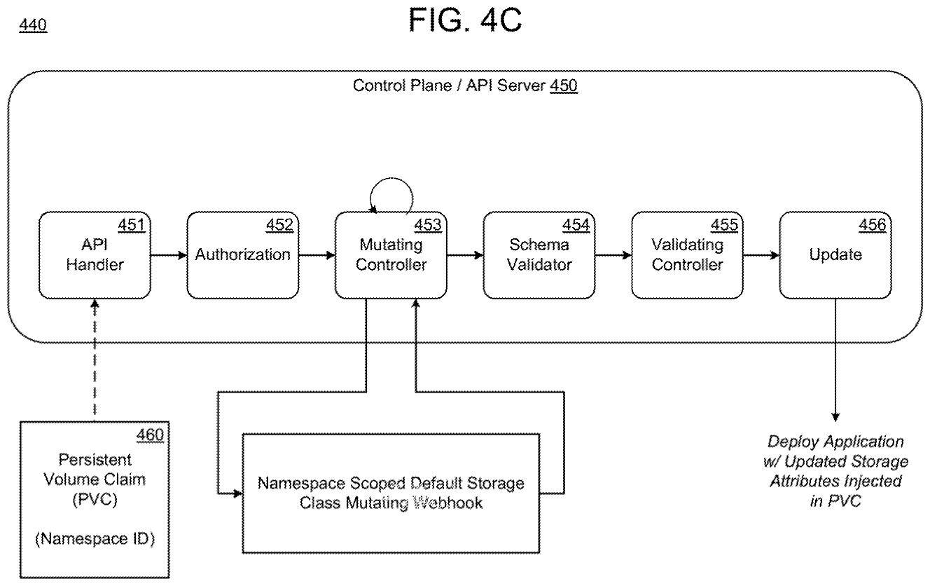

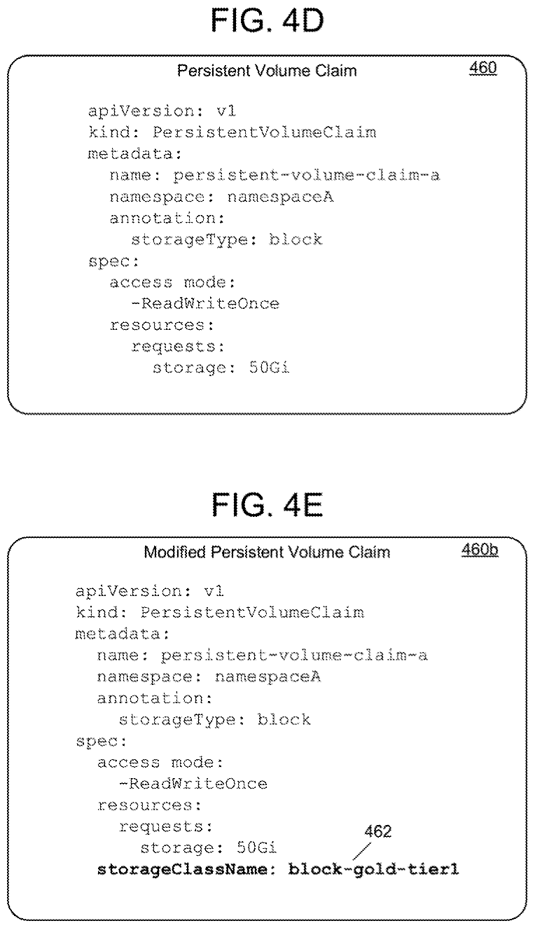

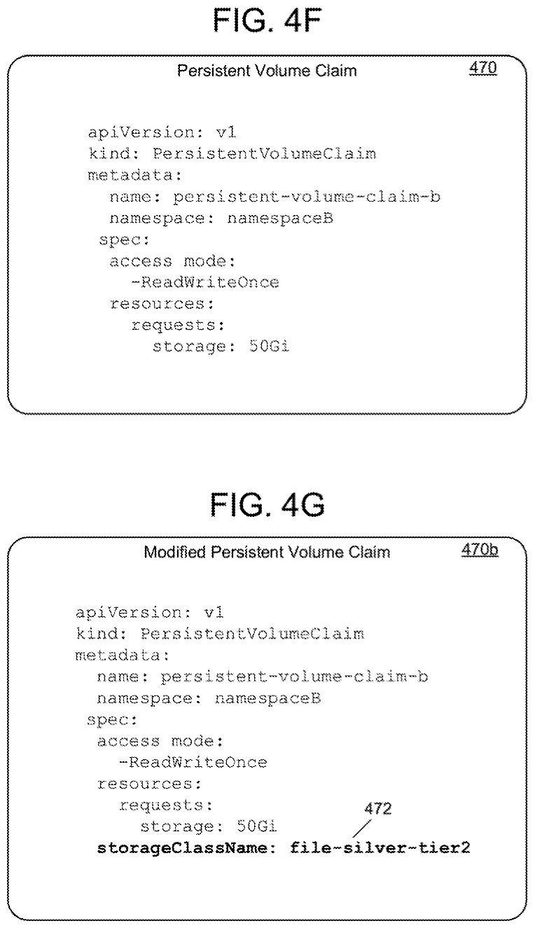

FIG. 4A illustrates an example of a virtual storage class 410 defined for a cluster according to example embodiments. In this example, the virtual storage class 410 is dedicated to the entire cluster of the KUBERNETES® server and is referred to as a “global” default storage class. An administrator of the cluster or other user may access the server via a user interface and create the virtual storage class 410 and subsequently modify the virtual storage class 410 after its creation. The virtual storage class 410 identifies a default quality of service (bronze) which corresponds to predefined resources for storage type and other parameters.

The virtual storage class 410 shown in FIG. 4A is a fallback default storage class for a cluster in the examples embodiments because the system described herein enables default storage classes to be set for a specific namespace. In other words, the user or admin can setup a default storage class that is scoped only to a namespace within a cluster, and not to an entire cluster which includes multiple namespaces. In this way, namespaces inside the same cluster can receive different default storage classes enabling better resource availability within the cluster.

FIG. 4B illustrates examples of configuration files which define different default storage classes for different namespaces in a same cluster according to example embodiments. Referring to FIG. 4B, configuration file 420 defines a default storage class for a namespace A. In particular, the configuration file 420 includes identifiers therein of a type of storage for the default storage class which in this example includes a “file-type” storage device with a quality of service parameter referred to as “gold”. The configuration file 420 thus scopes a default “file-based” storage for namespace A with a gold quality of service parameter. According to various embodiments, when a deployment request is received for an application that does not claim a specific storage class (i.e., it relies on default), and which is hosted in namespace A, the application will be dynamically assigned to a file-type storage system in the persistent volume of the cluster with gold quality of service, by default.

Meanwhile, configuration file 430 defines a default storage class for namespace B. In particular, the configuration file 430 includes an identifier 432 of a file type of storage for the default storage class which in this example includes silver level of quality of service. The configuration file 430 thus scopes a default NFS storage for namespace B with a lesser quality of service, but the same storage type (file). According to various embodiments, when a deployment request is received for an application that does not claim a specific storage class (i.e., it relies on default), and which is hosted in namespace B, will be dynamically assigned to a file storage system in the persistent volume of the cluster with silver quality of service, by default.

Although not shown in FIG. 4B, it should also be appreciated that a similar default storage class may be set for the cluster as a whole (including both namespace A and namespace B). Such a cluster-wide default storage class can be used as a fallback by the host platform when a namespace-scoped default storage class is not provided.

FIG. 4C illustrates a process of injecting a default storage class into a persistent volume claim 460 according to example embodiments. When a software application is to be deployed, a developer or other user may submit a deployment request to a cloud platform that relies on a KUBERNETES® cluster. The developer may also submit a persistent volume claim which is a file that can be appended to the software application and read by a control plane of the KUBERNETES® cluster. FIG. 4C illustrates an example 440 of a control plane 450 (also referred to herein as an API server) that receives the persistent volume claim 460 and dynamically modifies the content within the persistent volume claim to attach the default storage class.

Referring to FIG. 4C, the persistent volume claim 460 may be captured or otherwise retrieved by an API handler 451 of the control plane 450 in response to the deployment request from the user/developer or other system. The PVC 460 may include a specification of a software application associated with the PVC 460. The API handler 451 forwards the PVC 460 to an authorization controller 452 of the control plane 450 which identifies that the PVC 460 is not tied to a specific storage class. For example, the PVC spec may not explicitly specify the storage class name attribute, in the example of FIG. 4D. In response, the control plane 450 may interpret the missing storage class attribute as a request for a default storage class.

According to various embodiments, a mutating controller 453 within the control plane 450 may modify the PVC 460 shown in FIG. 4D to fill in a missing value which identifies the storage class based on a default storage class scoped to a namespace where the software application will be hosted. As an example, the mutating controller 453 may detect that the software application is to be deployed in namespace A of a cluster which includes a predefined block-level type default storage class 420. In this case, the mutating controller may modify the PVC 460 to include a missing value 462 which identifies a file-type storage access based on the gold level of service to the persistent volume of the cluster as shown in FIG. 4E.

The modified PVC 460b shown in FIG. 4E including the missing value 462 added therein can be validated for both schema by a schema controller 454 and for deployment by a controller 455. Furthermore, the validated modified PVC 460b can be used to update the application deployment process via an update module 456 of the control plane 450, and the software application is deployed on the cluster based on the modified PVC 460 where it is hosted within the identified namespace A.

FIG. 4F illustrates a persistent volume claim 470 submitted to a cluster according to another example embodiment. In particular, in this example, the PVC 470 includes an identifier of a namespace (namespace B) but not storage class attributes listed. In response, in FIG. 4G, the mutating controller 453 may modify the PVC 470 to include a missing value 472 which identifies a default file-type storage class scoped to namespace B identified from the PVC (e.g., a specification of the application within the PVC) to create a modified PVC 470b. In this example, the default storage class of namespace B has a lower quality of service (i.e., silver vs gold) and may have other attributes that are different than the default storage space scoped to namespace A including volume size, bandwidth, etc.

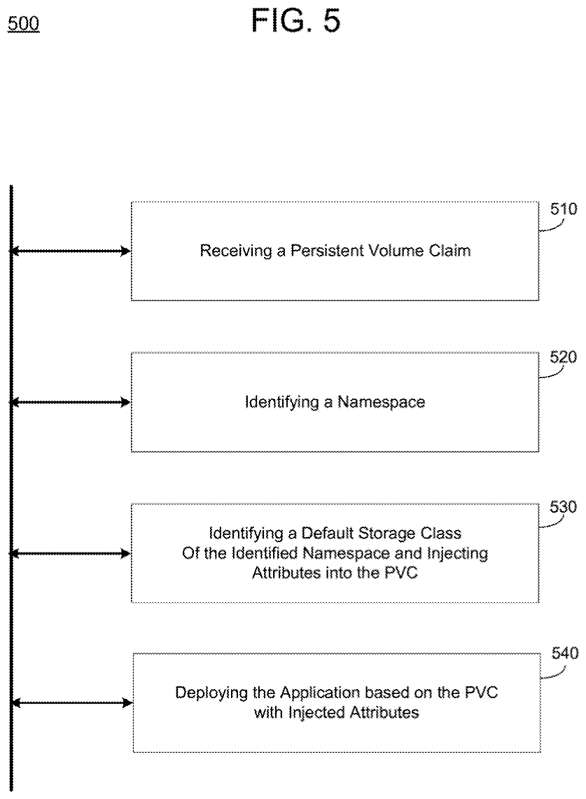

FIG. 5 illustrates a method 500 of injecting a default storage class scoped to a namespace into an application according to example embodiments. For example, the method may be performed by a KUBERNETES® cluster or other host system such as a cloud platform, a web server, a database, a distributed network of systems, and the like. Referring to FIG. 5, in 510, the method may include receiving, via an application programming interface (API) of a cluster, a persistent volume claim (PVC) with a specification of a software application.

In 520, the method may include identifying a namespace based on one or more attributes within the PVC. In 530, the method may include identifying a storage class which is declared as a default storage class for the identified namespace based on the one or more attributes within the PVC and injecting storage criteria of the default storage class into the specification of the software application. In 540, the method may include deploying the software application via a node within the identified namespace according to the predefined storage attributes of the default storage class injected into the specification of the software application.

In some embodiments, the identifying the default storage class may include identifying a configuration file of the identified namespace which defines a type of the default storage class, and the injecting comprises injecting an identifier of the defined type of the default storage class from the configuration file into the specification of the software application. In some embodiments, the deploying may include deploying the software application via the identified namespace of the cluster. In some embodiments, the deploying may further include assigning resources from the persistent volume to the software application deployed via the identified namespace based on the predefined storage attributes of the default storage class injected into the PVC.

In some embodiments, the receiving may include intercepting the PVC via a handler of the API, and the injecting may include injecting the predefined storage attributes via a control plane of the cluster. In some embodiments, the method may further include receiving, via the API, a second PVC with a second specification of a second software application to be hosted in a cluster, and in response, identifying storage class for PVC for second software application based on one or more attributes within the second PVC.

In some embodiments, the method may further include identifying a different type of default storage class that is assigned to the different namespace, injecting storage class name attribute with different type of default storage class into the PVC specification of the second software application, and deploying the second software application via a node within the identified namespace according to the predefined storage attributes of the different default storage class injected into the second specification. In some embodiments, the identifying may include identifying the namespace from among a plurality of namespaces within the cluster based on a namespace attribute stored in the PVC.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a processor configured to:
receive, via an application programming interface (API) of a cluster, a persistent volume claim (PVC) with attributes of a software application;
identify a namespace based on namespace attribute of the PVC;
identify a storage class declared as a default storage class for the identified namespace based on one or more other attributes of the PVC and injecting the identified storage class into the PVC specification of the software application; and
deploy the software application via a node within the identified namespace according to the predefined storage attributes of the storage class injected into the specification of the software application.

2. The apparatus of claim 1, wherein the processor is configured to identify a configuration file of the identified namespace which defines a type of the default storage classes, and then inject an identifier of the defined type of the default storage class from the configuration file into the specification of the software application.

3. The apparatus of claim 1, wherein the processor is configured to deploy the software application via the identified namespace of the cluster.

4. The apparatus of claim 3, wherein the processor is configured to assign resources from the persistent volume to the software application deployed via the identified namespace based on the predefined storage attributes of the default storage class injected into the PVC.

5. The apparatus of claim 1, wherein the processor is configured to intercept the PVC via a handler of the API, and inject the predefined storage attributes via a control plane of the cluster.

6. The apparatus of claim 1, wherein the processor is further configured to receive, via the API, a second PVC with a second specification of a second software application to be hosted in a cluster, and in response, identify storage class for PVC for the software application based on one or more attributes within the second PVC.

7. The apparatus of claim 6, wherein the processor is configured to identify a different type of default storage class that is assigned to the different namespace, inject predefined storage attribute of the different type of default storage class into the second specification of the second software application, and deploy the second software application via a node within the identified namespace according to the predefined storage attributes of the different default storage class injected into the second specification.

8. The apparatus of claim 1, wherein the processor is configured to identify the namespace from among a plurality of namespaces within the cluster based on a namespace attribute stored in the PVC.

9. A method comprising:
receiving, via an application programming interface (API) of a cluster, a persistent volume claim (PVC) with a specification of a software application;
identifying a namespace based on namespace attribute of the PVC;
identifying a storage class which is declared as a default storage class for the identified namespace based on one or more other attributes of the PVC and injecting storage criteria of the default storage class into the specification of the software application; and
deploying the software application via a node within the identified namespace according to the predefined storage attributes of the default storage class injected into the specification of the software application.

10. The method of claim 9, wherein the identifying the default storage class comprises identifying a configuration file of the identified namespace which defines a type of the default storage class, and the injecting comprises injecting an identifier of the defined type of the default storage class from the configuration file into the specification of the software application.

11. The method of claim 9, wherein the deploying comprises deploying the software application via the identified namespace of the cluster.

12. The method of claim 11, wherein the deploying further comprises assigning resources from the persistent volume to the software application deployed via the identified namespace based on the predefined storage attributes of the default storage class injected into the PVC.

13. The method of claim 9, wherein the receiving comprises intercepting the PVC via a handler of the API, and the injecting comprises injecting the predefined storage attributes via a control plane of the cluster.

14. The method of claim 9, wherein the method further comprises receiving, via the API, a second PVC with a second specification of a second software application to be hosted in a cluster, and in response, identifying a different namespace within the cluster for hosting the second software application based on one or more attributes within the second PVC.

15. The method of claim 14, wherein the method further comprises identifying a different type of default storage class that is assigned to the different namespace, injecting predefined storage attributes of the different type of default storage class into the second specification of the second software application, and deploying the second software application via a node within the identified namespace according to the predefined storage attributes of the different default storage class injected into the second specification.

16. The method of claim 9, wherein the identifying comprises identifying the namespace from among a plurality of namespaces within the cluster based on a namespace attribute stored in the PVC.

17. A computer-readable storage medium comprising instructions, that when read by a processor, cause the processor to perform a method comprising:
receiving, via an application programming interface (API) of a cluster, a persistent volume claim (PVC) with a specification of a software application;
identifying a namespace based on a namespace attribute of the PVC;
identifying a storage class which is declared as a default storage class for the identified namespace based on one or more other attributes of the PVC and injecting storage criteria of the default storage class into the specification of the software application; and
deploying the software application via a node within the identified namespace according to the predefined storage attributes of the default storage class injected into the specification of the software application.

18. The computer-readable storage medium of claim 17, wherein the identifying the default storage class comprises identifying a configuration file of the identified namespace which defines a type of the default storage class, and the injecting comprises injecting an identifier of the defined type of the default storage class from the configuration file into the specification of the software application.

19. The computer-readable storage medium of claim 17, wherein the deploying comprises deploying the software application via the identified namespace of the cluster.

20. The computer-readable storage medium of claim 19, wherein the deploying further comprises assigning resources from the persistent volume to the software application deployed via the identified namespace based on the predefined storage attributes of the default storage class injected into the PVC.
